(19) United States
(12) Patent Application Publication
(10) Pub. No.: US 2014/0188558 A1
(43) Pub. Date: Jul. 3, 2014

(54) SUBSCRIPTION PRICING SYSTEM, METHOD AND COMPUTER PROGRAM PRODUCT THEREFOR

(71) Applicant: TrueCar, Inc., Santa Monica, CA (US)

(72) Inventors: Michael Wunsch, Los Angeles, CA (US); Zixia Wang, Santa Monica, CA (US); Michael D. Swinson, Santa Monica, CA (US)

(73) Assignee: TrueCar, Inc., Santa Monica, CA (US)

(21) Appl. No.: 14/101,118

(22) Filed: Dec. 9, 2013

Related U.S. Application Data
(60) Provisional application No. 61/747,834, filed on Dec. 31, 2012.

(51) Int. Cl. G06Q 30/02

(52) U.S. Cl. CPC G06Q 30/0206; G06Q 30/0202
USPC 705/7.31

(57) ABSTRACT

A method for subscription pricing may include estimating a number of leads to be provided by an entity to a dealer in a dealer network associated with the entity; estimating a price per lead based at least in part on the estimated number of leads; determining a preliminary subscription price for the dealer based on the estimated number of leads and the estimated price per lead; and applying one or more decision rules imposing one or more constraints to the preliminary subscription price to thereby determine a final subscription price for the dealer. The one or more decision rules may be applied depending upon whether the dealer is a potential subscriber member or an existing member of the dealer network associated with the entity.

### CROSS-REFERENCE TO RELATED APPLICATION(S)

This is a conversion of, and claims a benefit of priority under 35 U.S.C. §119(e) from U.S. Provisional Application No. 61/747,834, filed Dec. 31, 2012, entitled “SUBSCRIPTION PRICING SYSTEM, METHOD AND COMPUTER PROGRAM PRODUCT THEREFOR,” which is hereby incorporated by reference for all purposes in its entirety as if fully set forth herein.

### TECHNICAL FIELD

This disclosure relates generally to subscription pricing. More particularly, embodiments disclosed herein relate to a methodology, system, and computer program product for determining subscription rates based on forecasted leads.

### BACKGROUND

Today, many people and entities alike use the Internet for selling and purchasing products or services. A sale of a product or service may occur online after a lead that identifies prospective customers has been provided from a lead supplier, where the lead supplier may be a party other than the seller of the product or service.

In pay per sale models, lead generators are paid on the basis of the number of sales that are directly generated by an advertisement or leads. In pay per sale models, dealers may pay a lead generation service provider a fixed fee for each product sold. In some states or jurisdictions, pay per sale models are not allowed due to regulatory restrictions. This creates a need for subscription pricing models where a dealer may pay a lead generation service provider a fixed subscription fee on a monthly (or other time interval) basis in exchange for a number of leads.

Conventional subscription pricing models may be geography based and limit the degree of potential price or volume differences between dealers. Furthermore, conventional subscription pricing models may not accurately predict how many leads may be provided, for a given time period, to an individual dealer, while managing monetization and dealer retentions. Yet, dealers may desire to receive estimates of guaranteed leads and associated subscription fees before they decide to become subscribers to receive leads from the lead generation service provider.

In view of the above, there is a need for pricing subscriptions based on estimate leads. Embodiments disclosed herein can address this need and more.

### SUMMARY OF THE DISCLOSURE

Embodiments disclosed herein are directed to methods, computer program products, and systems implementing a subscription based model. In some embodiments, a method for subscription pricing may include estimating a number of leads to be provided by an entity to a dealer in a dealer network associated with the entity; estimating a price per lead based at least in part on the estimated number of leads; determining a preliminary subscription price for the dealer based on the estimated number of leads and the estimated price per lead; and applying one or more decision rules imposing one or more constraints to the preliminary subscription price to thereby determine a final subscription price for the dealer.

In this disclosure, the term “dealer” is used to refer to a member in a network (e.g., a dealer network) associated with an entity. Other terms such as “vendor,” “distributor,” “retailers,” “sales outlet,” “subscriber,” and the like may be used. The entity may provide leads to members of the network in exchange for a portion (e.g., a percentage) of revenue generated from the sales (closings) resulted from the leads provided by the entity. One example of a dealer may be a car dealership. The entity may own and operate a web site through which leads may be generated.

In some embodiments, the method may further include adjusting the final subscription price for the dealer based at least in part on an actual number of sales by the dealer, the sales resulting from leads provided by the entity to the dealer. In some embodiments, the method may further constraining or dampening a variance of the estimated price per lead and an actual number of leads provided by the entity to the dealer. In some embodiments, the one or more decision rules may be applied depending upon whether the dealer is a potential subscriber member or an existing member of the dealer network associated with the entity.

In some embodiments, the estimated price per lead is determined using a target price per sale. Accordingly, the method may further include determining a sales estimate for the dealer based at least in part on the estimated number of leads for the dealer and a close rate for the dealer; and determining the target price per sale using the sales estimate for the dealer. In some embodiments, the close rate for the dealer can be an estimated close rate determined based on marketing data, one or more geographic factors, one or more seasonality factors, historical data associated with the dealer over a time period, or a combination thereof.

Some embodiments may include a computer program product having at least one non-transitory computer readable medium storing instructions translatable by at least one processor to implement the method.

Some embodiments may include a system having at least one processor and at least one non-transitory computer readable medium storing instructions translatable by the at least one processor to implement the method.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features and wherein:

FIG. 1 depicts a diagrammatic representation of a network architecture in which embodiments disclosed herein may be implemented.

FIG. 2 is flowchart illustrating an example method for determining a subscription rate for a dealer according to an embodiment.

FIG. 3A illustrates example dampening factors applied to over delivery.

FIG. 3B illustrates example dampening factors applied to under delivery.

FIG. 4 depicts a diagrammatic representation of an example method for determining subscription rates according to some embodiments.

FIG. 5 depicts a diagrammatic representation of an example sales estimate determination according to an embodiment.

FIG. 6 depicts a diagrammatic representation of example lead balancing according to an embodiment.

FIG. 7 depicts a diagrammatic representation of example lead balancing according to an embodiment.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail.

It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure. Embodiments discussed herein can be implemented in suitable computer-executable instructions that may reside on a computer readable medium (e.g., a hard disk (HD)), hardware circuitry or the like, or any combination.

Embodiments disclosed herein can 1) estimate the number of leads a dealer will receive from an entity over a given period of time, 2) determine subscription pricing based on a lead estimation and sales estimate for a dealer, and 3) apply constraining decision rules to the subscription pricing. In one embodiment, estimating a number of leads a dealer will receive over a time period may be based on historical demand, conversion rates, close rates, and/or current active dealer network. As discussed above, the entity may own and operate a web site through which leads may be generated.

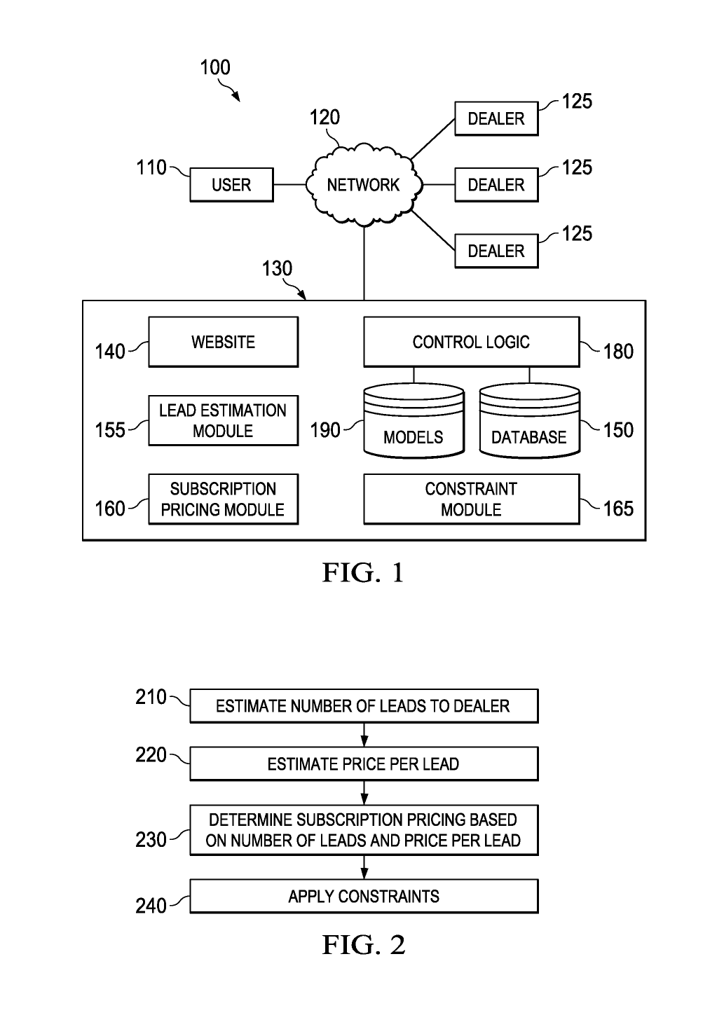

Turning now to FIG. 1 which depicts a diagrammatic representation of a network architecture in which embodiments disclosed herein may be implemented. System 100 may include entity computing environment or network 130 that is owned and operated by an entity.

Entity computing environment or network 130 may include one or more server machines that implement or are in communication with one or more server machines that implement web site 140 that allows a user of device 110 to conduct product research. As illustrated in FIG. 1, user 110 may interact (via a client device communicatively connected to one or more servers hosting web site 140) with web site 140 to conduct their product research, and perhaps purchase a new or used vehicle through web site 140. In one embodiment, the user's vehicle buying process may begin when the user directs a browser application running on client device 110 to send a request over a network connection (e.g., via network 120) to web site 140. The user's request may be processed through control logic 180 coupled to web site 140 within entity computing environment 130. The user request may include identification of dealers having vehicles corresponding to a desired vehicle configuration. In this case, the user can be a lead generated through web site 140 and provided to the dealers thus identified. The user may purchase (i.e., “close a sale”) the vehicle presented from one of the dealers identified on web site 140.

An example of a client device 110 can include a central processing unit (“CPU”), a read-only memory (“ROM”), a random access memory (“RAM”), a hard drive (“HD”) or storage memory, and input/output device(s) (“I/O”). I/O can include a keyboard, monitor, printer, and/or electronic pointing device. Examples of an I/O may include mouse, trackball, stylus, track pad, touchpad, or the like. Further, examples of a suitable client device can include a desktop computer, a laptop computer, a personal digital assistant, a cellular phone, a tablet device, or nearly any device capable of communicating over a network.

A server machine may have hardware components such as a CPU, ROM, RAM, HD, and I/O. Portions of the methods described herein may be implemented in suitable software code that may reside within ROM, RAM, HD, and may include lead estimation module 155, subscription pricing module 160, constraint module 165, database 150, model(s) 190 or a combination thereof.

In some embodiments, computer instructions implementing an embodiment disclosed herein may be stored on a digital access storage device array, magnetic tape, floppy diskette, optical storage device, or other appropriate computer-readable storage medium or storage device. A computer program product implementing an embodiment disclosed herein may therefore comprise one or more computer-readable storage media storing computer instructions translatable by a CPU to perform an embodiment of a method disclosed herein. In an illustrative embodiment, the computer instructions may be lines of compiled C++, Java, or other language code. Other architectures may be used. For example, the functions of control logic 180 may be distributed and performed by multiple computers in enterprise computing environment 130. Accordingly, each of the computer-readable storage media storing computer instructions implementing an embodiment disclosed herein may reside on or accessible by one or more computers in enterprise computing environment 130.

The various software components and subcomponents, including web site 140, lead estimation module 155, subscription pricing module 160, constraint module 165, database 150, control logic 180, and model(s) 190, may reside on a single server computer or on any combination of separate server computers. In some embodiments, some or all of the software components may reside on the same server computer.

Entity computing environment 130 may further implement or be in communication with one or more servers that implement a subscription pricing system in accordance with embodiments. In some embodiments, a subscription pricing system may include lead estimation module 155, subscription pricing module 160, and constraint module 165.

Lead estimation module 155 may be configured to estimate the number of leads given to each dealer 125 based on demand of a product (e.g., a vehicle or a vehicle of a particular trim or configuration). In one embodiment, lead estimation module 155 may estimate the number of leads given to each dealer 125 in a dealer network associated with the entity by estimating a demand during a time period based on historical demand data, leveraging historical estimates for a demand of a product in the time period based on seasonal and marketing expense data and/or any additional anticipated demand shift.

After estimating a demand of a product for the time period, lead estimation module 155 may determine a number of assigned leads N_{L} to particular dealers 125. In one embodiment, lead estimation module 155 may utilize dealer scoring algorithm (DSA) to determine a number of anticipated leads that dealer 125 may receive over the period of time in a geographic region. One embodiment of an example DSA is described in U.S. patent application Ser. No. 13/534,930, filed Jun. 27, 2012, entitled “METHOD AND SYSTEM FOR SELECTION, FILTERING OR PRESENTATION OF AVAILABLE SALES OUTLETS,” which is incorporated by reference in its entirety as if fully set forth herein. Other suitable methods may also be employed.

In some embodiments, control logic 180 may be capable of determining a probability of closing a sale based in part on a probability of a dealer 125 selling a particular product to a customer and the probability of the customer buying the particular product from that particular dealer 125. In some embodiments, information about dealers 125 may be stored on database 150 which is accessible by control logic 180 as shown in FIG. 1.

More specifically, control logic 180 can be configured to filter, select, and present a list of dealers 125 with a high probability of closing a sale to a customer utilizing model(s) 190. Model(s) 190 may be based in part on the probability of a dealer 125 to sell a product to a customer and the probability of a customer buying the product from the same dealer 125 that may utilize information from a plurality of system components, including data from a list of available dealers and their performance history from database 150 and/or dealers, information associated with users stored in database 150, and/or information associated with dealers 125 stored in database 150.

The estimated demand volume and number of leads thus determined can be used to determine an estimated price per sale (as opposed to an actual price per sale), which can then be used to determine a subscription rate. Subscription pricing module 160 may be configured to determine a subscription rate for the leads given to dealer 125.

In some embodiments, to determine a subscription rate for a dealer, subscription pricing module 160 may first determine a sales estimate for a dealer based on an estimated number of leads for the dealer, a close rate of the dealer, and/or seasonality adjustments over a time period. One example of a time period may be a quarter of a year. In one embodiment, a sales estimate of a dealer may be represented by the following equation:

Sales estimate for a dealer=N_{L}*(CR)*f(seasonality) [EQ. 1]

where N_{L} represents a number of leads, CR represented a close rate of the dealer, and f(seasonality) represents seasonality factor adjustments.

From here, a price per lead can be estimated based on a target price per sale, which, in one embodiment, is defined as follows:

$${P}_{S , Target} = \frac{{P}_{L} {N}_{L}}{{N}_{L} ( C R ) * f ( seasonality )} \qquad [ EQ . 2 ]$$

where P_{S,Target} represents the target price per sale, and P_{L} represents a price per lead. In some embodiments, the close rate of a dealer may be a forecasted close rate adjusted by one or more geographic factors, and/or an estimated close rate determined based on marketing data, seasonality factors and/or historical data associated with the dealer over a time period.

Accordingly, in one embodiment, the price per lead P_{L} can be determined as follows:

P_{L}=P_{S,Target}*(CR)*f(seasonality) [EQ. 3]

In some embodiments, the estimated price per lead can then be used to determine a subscription rate for the particular dealer R_{D} as follows:

R_{D}=P_{L}N_{L} [EQ. 4]

In some embodiments, constraint module 165 may apply one or more constraints to either or both of the price per lead or the number of leads in the resulting subscription rate (which is deemed a preliminary subscription rate) to arrive at a final subscription rate.

In one embodiment, subscription pricing module 160 may be configured to determine subscription pricing for dealer 125 such that the revenue from the subscription pricing can be comparable to the revenue received from a pay per sale model. One embodiment of a pay per sale model is described in U.S. Provisional Application No. 61/745,191, filed Dec. 21, 2012, entitled “PAY-PER-SALE SYSTEM, METHOD AND COMPUTER PROGRAM PRODUCT THEREFOR,” which is incorporated by reference in its entirety for all purposes as if fully set forth herein.

Turning now to FIG. 2, one embodiment of a method for determining a subscription rate for a dealer is depicted. At step 210, the number of leads delivered to a dealer over a time period may be estimated by lead estimation module 155. In one embodiment, the number of leads delivered to a dealer may be determined based on historical data associated with demand for products (e.g., vehicles) over the time period, a DSA, and anticipated distributional shifts over the time period. In one embodiment, the time period may be a day, week, month, quarter, or any other desired time period.

At step 220, the subscription pricing module may estimate a price per lead based on the estimated number of leads a dealer may receive, the dealer's close rate and seasonality factors.

At step 230, preliminary subscription pricing for a dealer may be determined by the subscription pricing module based on the estimated price per lead and the estimated number of leads a dealer may receive.

At step 240, constraints may be applied to the preliminary subscription pricing by the constraint module 165 to obtain a final subscription pricing. In one embodiment, constraints based on business rules may be applied to limit the variance in the subscription pricing and/or the number of leads delivered to a dealer over a time period.

In some embodiments, the subscription rate determined for a particular dealer can be adjusted according to one or more decision rules. Constraint module 165, as depicted in FIG. 1, may be configured to apply such decision rules. For example, the subscription pricing may be adjusted so that the revenue from the subscription is comparable to the revenue received from a pay per sale model. Further, decision rules may be applied to the subscription rate for the particular dealer to constrain the variance of the price per lead associated with a dealer and/or the number of leads given by the entity to the dealer. For example, as will be discussed in greater detail below, if the subscription rate is set at a particular value based on an estimate of the number of closings (of sales), if the actual number of closings is higher than anticipated, then the subscription price may be adjusted upwards. However, if the amount of that increase is too large, subscribers may balk. Accordingly, the variance may need to be dampened. In one embodiment, one or more decision rules may be applied depending upon whether a dealer is a potential subscriber member or an existing member of a dealer network associated with the entity.

The decision rules may impose different types of constraints including: 1) capping the subscription rate (as defined by the price per lead times the estimated number of leads) within certain bounds, wherein the bounds define a number of leads; and 2) changing moderation limits where the amount of change in the subscription rate for an existing dealer from one period to the next (subscription rate volatility) must be confined within a set range.

In one embodiment, if a close rate of a dealer has increased over a time period, it may be desired to increase the subscription price for the dealership to be more comparable to a price per sale model. However, in practice it may be difficult to modify the subscription prices for dealers due to business practices. Examples of a decision rules may limit adjustments to the number of leads that are guaranteed in a subscription and/or the price per lead that is charged.

In one embodiment, the decisions rules may cap the change in the number of leads given to a dealer. For example, if the subscription rate for a dealer is $2000 for 100 leads and the dealer increased his closing rate based on the leads. The number of leads given to the dealer may be decreased, but the reduction of the number of leads may be capped. In another example embodiment, if a subscription rate for a dealer is $2000 dollars and the dealer made 20 sales over a time period, the price per sale may be determined as $100 per sale. However, the desired revenue per sale is closer to $325 per sale. Therefore, it may be desired to increase the revenue received per sale, but a constraint may limit the allowable increase in the subscription rate for a dealer, which may be represented as a dollar amount or a percentage of the current subscription price.

In one embodiment, a number of leads allotted to a dealer may be balanced if the dealer has not received a number of leads guaranteed to the dealer over a time period. More specifically, the number of anticipated leads a dealer may receive, as determined by a DSA, may be modified so that the dealer receives a number of guaranteed leads that is reflective to the revenue thus generated.

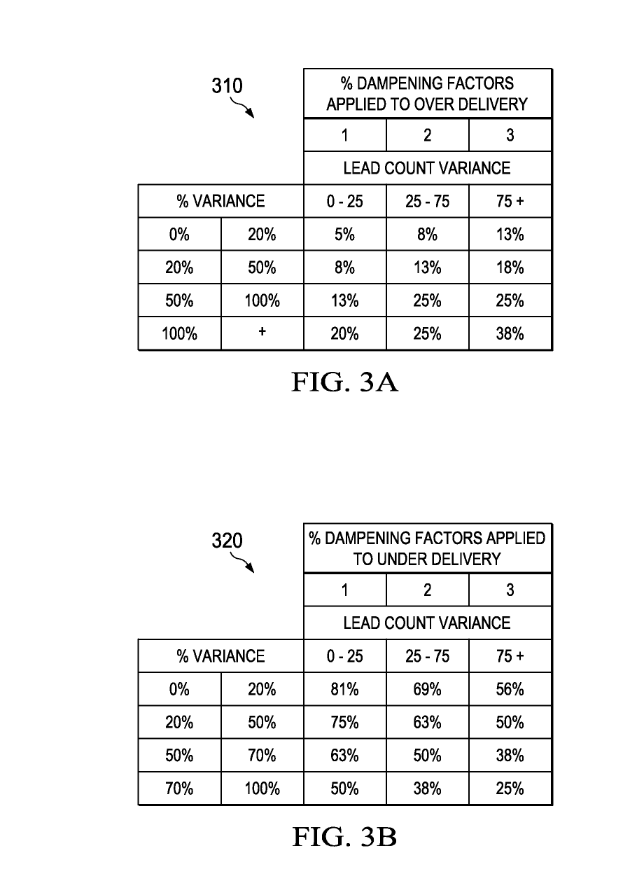

FIG. 3A depicts one embodiment for applying dampening constraints to a number of anticipated leads for lead guarantee changes). Table 310 depicts dampening factors that are applied if there is an over delivery of the number of actual leads delivered to a dealer. Additionally, Table 320 depicts dampening factors that are applied if there is an under delivery of the number of actual leads delivered to a dealer. One skilled in the art will appreciate the dampening factors may be configurable and may include additional dampening factors.

The columns in Tables 310 and 320 are associated with a number indicating a lead variance associated with a number of anticipated leads and the number of leads actually delivered to a dealer. The rows in Tables 310 and 320 are associated with a percentage indicating the lead variance associated with the number of anticipated leads and the number of leads actually delivered to a dealer.

In Table 310, as the number and/or percentage of lead variance increases, the dampening factor of the number of leads delivered to a dealer may increase. Thus, as a lead count variance increases, the dampening factor applied increases. Similarly, as the percent variance, i.e., the percent difference from the number of leads guaranteed increases, the dampening factor increases. In Table 320, as the number and/or percentage of lead variance increases, the dampening factor of the number of leads delivered to a dealer may decrease. If the lead count decreases, then the dampening factor likewise decreases. As shown by the vertical axis, if the percent variance below the guaranteed value increases, the dampening factor decreases. Accordingly, there are different dampening factors applied to dealers that experience an over delivery of leads versus an under delivery of leads.

In one embodiment, decision rules for price per lead may be associated with a price per sale (PPS) equivalence value for a price per lead (PPL). If the current PPL is less than the PPS equivalence value, then the PPL value will increase to be closer to the PPS equivalence value.

In one embodiment, there may be a maximum increase value. For example, a decision rule for PPL changes may specify that, if the PPS equivalence value of PPL is greater than or equal to twenty dollars ($20) and the current PPL is less than twenty dollars ($20), then the current PPL may increase to twenty dollars ($20), subject to a maximum increase of seven dollars ($7). The maximum increase value may be any value based on empirical data, geographical reasons, or any desired variable. In some embodiments, a minimum price per lead may be maintained. For example, a decision rule for PPL changes may specify that the overall minimum PPL is ten dollars ($10). Other values may be used.

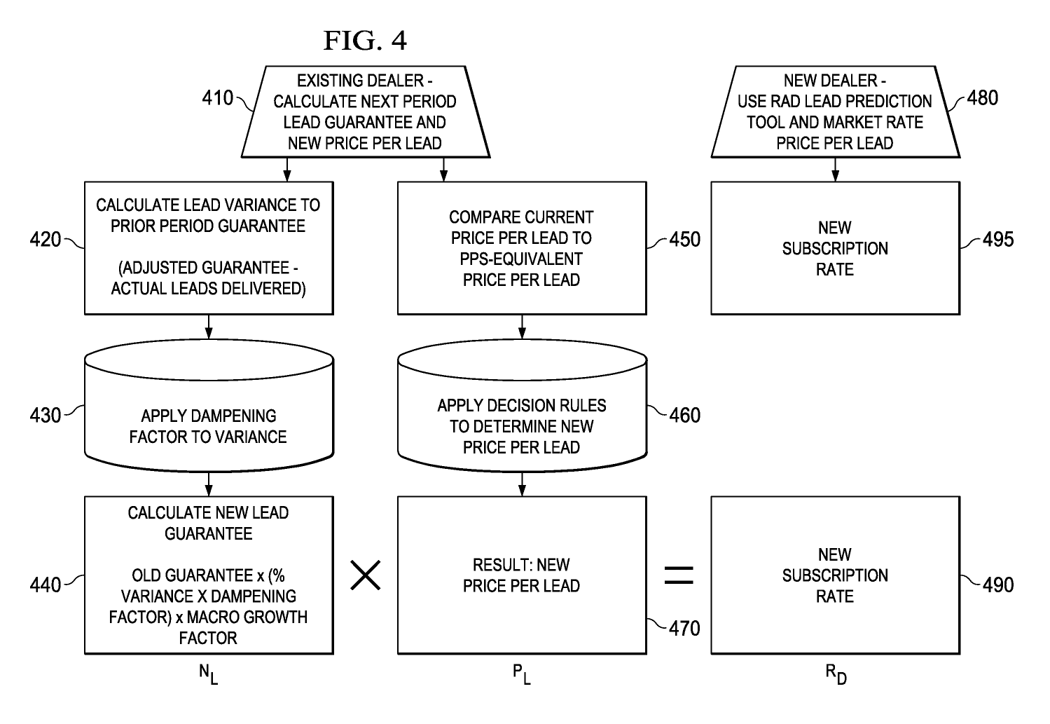

Turning now to FIG. 4, one embodiment of a method for how subscription rates may be determined differently depending upon a subscriber or potential subscriber's status is depicted.

At step 410, a subscription rate for an existing dealer for a particular period may be determined. In one embodiment, the existing dealer may have a prior lead guarantee and a prior price per lead equivalent. In one embodiment, for example, a dealer may be guaranteed 500 leads at $12 for a price of $6000.

The process according to embodiments may include determining a lead guarantee and a new price per lead for the dealer based on historical data associated with the dealer. One skilled in the art will appreciate that it might not be required to determine a lead guarantee and/or a new price per lead for the dealer. Furthermore, one skilled in the art will appreciate that the following steps are not sequential steps and may be performed in various orders and/or simultaneously.

At step 420, a lead variance for a prior time period may be determined. The lead variance may be determined based on the difference between the number of leads anticipated to be delivered to the dealer and the number of leads actually delivered to the dealer. In some embodiments, the prior time period may be a prior subscription period or periods. Following the above example, suppose 500 leads were guaranteed, but only 350 delivered, then the variance of 150 would correspond to a 30% variance. This may be adjusted to reflect the number of days the dealer was active during the period.

At step 430, a dampening factor based upon the lead variance may be determined. Examples of how to determine dampening factors based on variance are discussed above with reference to FIG. 3A. In the example illustrated, the 30% variance results in a 50% dampening factor. It is noted, however, that other factors or constraints may be applied.

At step 440, a new lead guarantee number may be determined. In one embodiment, the lead guarantee may be based on the prior lead guarantee, the dampening factor, and/or any additional factor, such as a macro growth factor. In particular, in one example, the new guarantee may be obtained from multiplying the prior lead guarantee, the dampening and variance factors, and the macro growth factor. For example, a new lead guarantee of 510 may be obtained from 500×(1+(−30% variance×50% dampening))×1.2 macro growth factor.

At step 450, the current price per lead value for the existing dealer may be compared to a price per sale equivalent value indicating the price per lead the dealer would pay if using a price per sale model. For example, the current cost per lead could be $12, while the PPS-equivalent CPL could be $22.

At step 460, decision rules, such as those described above, may be applied to the price per lead value based on the comparison in step 450.

In step 470, a new price per lead value may be determined. In one embodiment, if the price per lead value is below a price per sale equivalent value, then it may be determined that the price per lead value should be increased. For example, applying the decision rules described above, a price of $19 per lead may result (due to the maximum increase of $7).

In step 490, the new subscription rate for the dealer may be determined based on the lead guarantee and the price per lead value. The subscription rate may be determined by multiplying the lead guarantee and the price per lead value. For example, a new subscription rate of $9,690 may be obtained by multiplying the new guarantee of 510 by the new price of $19.

If a new dealer desires to subscribe to receive leads, then at step 480, historical and empirical data may be collected to determine an estimated number of leads the new dealer may receive and a market rate for the price per lead.

At step 495, the subscription rate for the new dealer may be determined by multiplying the estimated number of leads for the dealer by a market rate price per lead (N_{L}P_{L}). In one embodiment, the initial subscription rate for a new dealer may be determined without applying any constraints to the subscription rate. In some embodiments, the initial subscription rate for the new dealer may be the same as that obtained in step 490 for an existing dealer.

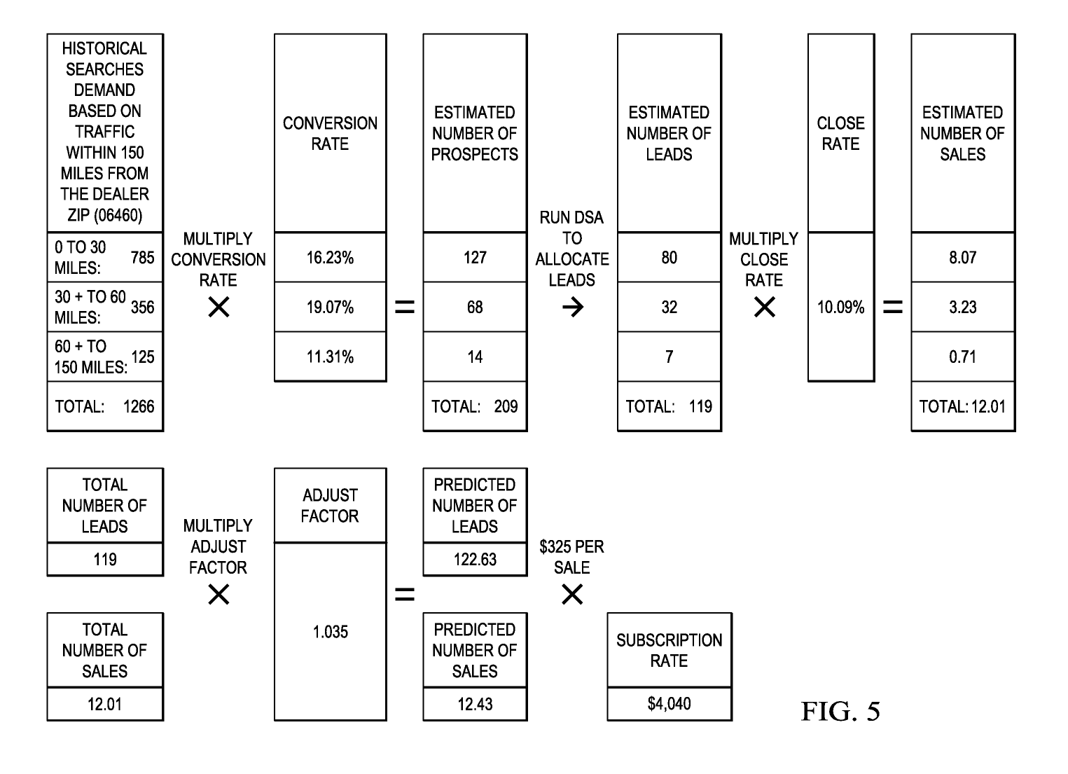

Turning now to FIG. 5, which depicts a lead estimation example illustrating how the leads and sales estimates can be determined by one embodiment of a lead estimation module disclosed herein.

In this example, a target Acura dealer is located in Milford, Conn. 06460. The search demand data within a 150 miles radius from the dealer zip code 06460 is obtained from traffic data in the past 60 days (e.g., via web site 140). Suppose the 150 miles radius can be divided into three ranges:

to 30 miles, 30+ to 60 miles, and 60+ to 150 miles, searches in each radius range can multiply with the conversion rates of each radius range to get the estimated number of prospects.

In this example, the historical searches for these ranges are 785, 356, and 125, respectively, and the conversion rates for these ranges are 16.23%, 19.07%, and 11.31%, respectively. Thus, in this example, the estimated number of prospects for the 0 to 30 miles range is 127, the estimated number of prospects for the 30+ to 60 miles range is 68, and the estimated number of prospects for the 60+ to 150 miles range is 14, bringing the total estimated number of prospects within 150 miles from the dealer zip code 06460 to 209.

At this point, the above-referenced DSA can be used to allocate the leads and decide if the target dealer would be displayed and get the lead. In this example, the DSA may determine that 80 leads within the 0 to 30 miles range would be allocated to the target dealer, 32 leads within the 30+ to 60 miles range would be allocated to the target dealer, and 7 leads within the 60+ to 150 miles range would be allocated to the target dealer, bringing the total estimated number of leads allocated to the target dealer to 119. Suppose the close rate for the target dealer is 10.09%, the resulting estimated number of sales can then be determined by multiplying the estimated number of leads in each radius range with the close rate, bringing the total estimated number of sales by the target dealer to 12.01. The total number of estimated leads and the total estimated number of sales can be adjusted by multiply an adjusted factor which account for seasonal effect. In this example, a seasonality factor of 1.035 is applied, giving the target dealer 122.63 predicted number of leads and 12.43 predicted number of sales out of those leads.

The subscription rate would then be a predetermined amount per sale times 12.43. In some embodiments, an amount per sale of $325 may be used (although other values are also contemplated), resulting in a subscription rate of $4,040.

Those skilled in the art will appreciate that the example described above is illustrative and non-limiting. For example, the search demand data may be obtained from a data service provider over a time period, which may be a day, week, month, quarter, or any desired time period. Additionally, searches associated with a vehicle configuration may be grouped in many ways such as by a requesting visitor's locale, one or more features of the vehicle configuration, etc. Furthermore, the proximity to the dealer zip code may be categorized in various ways based on certain criteria such as a radial distance from the dealer zip code, population density, driving distance from the target dealer, etc.

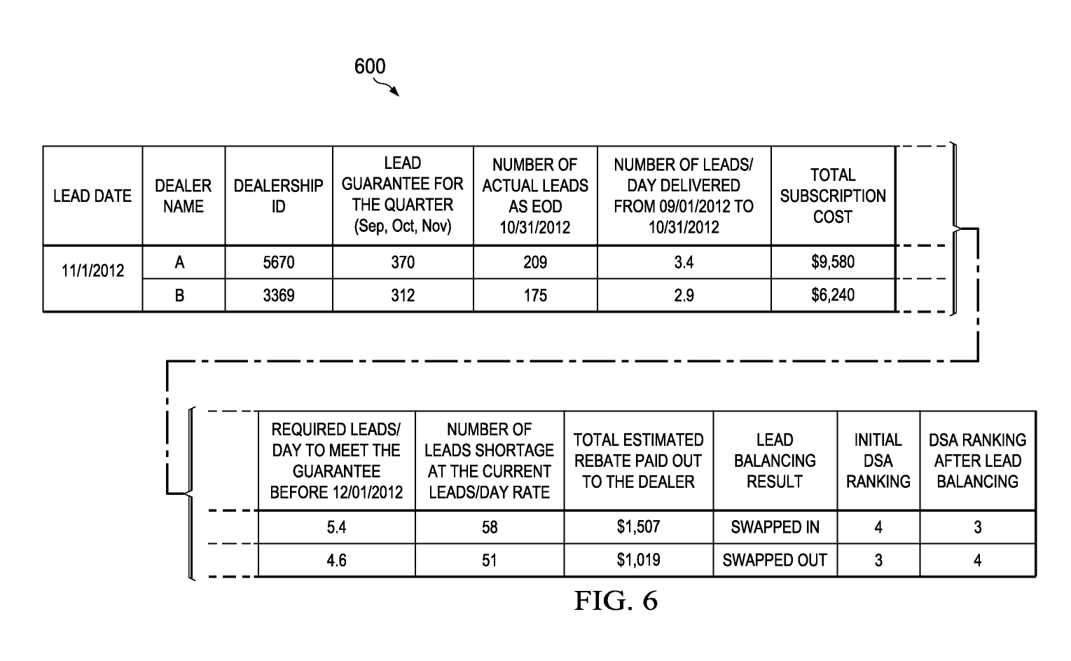

FIG. 6 depicts a lead balancing example illustrating how lead balancing can help ensure dealers get their prescribed number of leads. According to one embodiment disclosed herein, the lead balancing process may adjust a DSA's optimal assignment of leads.

Table 600 depicts lead balancing affecting a DSA ranking of dealers to balance leads distributed to dealers. In this example, a lead period begins on Sep. 1, 2012 and ends Dec. 1, 2012. During the lead period Dealer A is guaranteed 370 leads and Dealer B is guaranteed 312 leads. During the first two months of the lead period in this example, Dealer A has received 209 leads at a rate of 3.4 leads per day and Dealer B has received 175 leads at a rate of 2.9 leads per day. For Dealer A to receive the guaranteed 370 leads over the lead period, Dealer A should receive 5.4 leads per day for the remaining time in the lead period. For Dealer B to receive the guaranteed 312 leads over the lead period, Dealer B should receive 4.6 leads per day for the remaining time in the lead period.

Further, the subscription cost for Dealer A is $9,580 or $25.89 per lead and the subscription cost for Dealer B is $6,240 or $20 per lead. In this example, if the current pace of leads delivered to the dealers continues, Dealer A will receive 58 leads less than the guaranteed 370 leads over the lead period and Dealer B will receive 51 leads less than the guaranteed 312 leads over the lead period. Therefore, if the current pace of leads delivered to the dealers continues, Dealer A will receive a rebate of $1,507 and Dealer B will receive a rebate of $1,019 due to receiving less than the guaranteed number of leads over the lead period.

Accordingly, in this example, the number of leads per day delivered to meet the guaranteed number of leads over the lead period is higher for Dealer A than for Dealer B, and the total estimated rebate paid out to the dealers over the lead period is higher for Dealer A than for Dealer B. Therefore, lead balancing is implemented to switch the DSA rank between Dealer A and Dealer B. In this example, the initial DSA ranking for Dealer A is 4 and the initial ranking DSA ranking for Dealer B is 3. To balance the number of leads given to the dealers, Dealer A's DSA rank may be switched to 3 and Dealer B's DSA rank may be switched to 4.

The lead balancing data may be logged so a system can determine what adjustments were made to the DSA. However, in other embodiments, determining lead and sales estimates, the adjustments to the DSA may be filtered to discern an estimated number of leads and sales without lead balancing. Therefore, in embodiments, the number of estimated number of leads and sales may be determined without lead balancing. Those skilled in the art will appreciate that the example described above is illustrative and non-limiting.

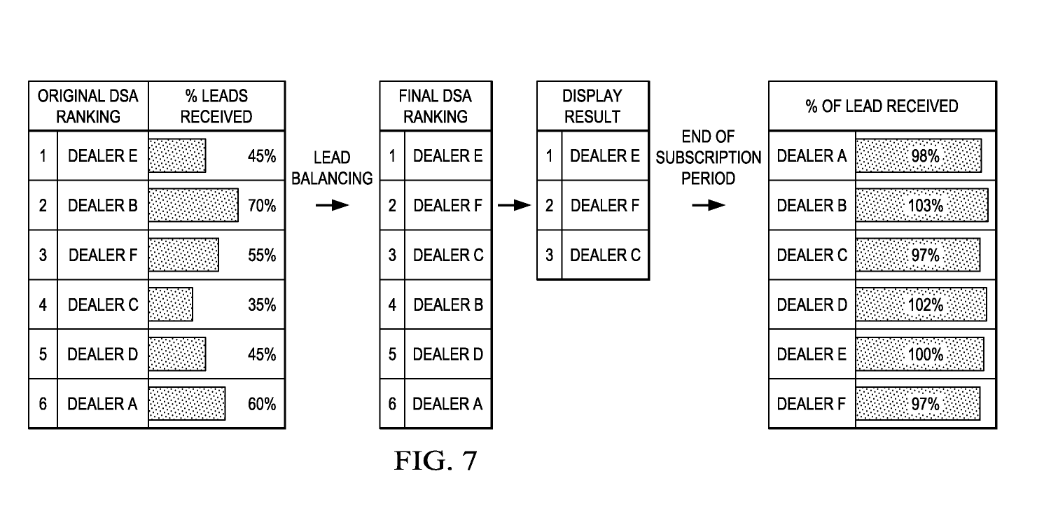

FIG. 7 depicts another example of lead balancing. As noted above, lead balancing rules may help dealers get their expected number of leads. If one dealer is ahead on leads but another dealer in the similar area is behind on leads, DSA rankings may be adjusted according to the number of leads they have already received. The dealer that is ahead on leads may be swapped out for the dealer that is behind on leads, so the objective will be to ensure at a minimum that both dealers would hit their goal on lead amount at the end of the subscription period.

In the example illustrated, dealers A-F are listed in order of their original DSA ranking and, for example, in the middle of the subscription stage. As shown, dealer B has already reached 70% of its expected lead amount, but dealer C is only at 35% of its expected lead amount. A lead balancing rule might replace dealer B with dealer C in the top three results being displayed to the user, so that the dealer that is short on leads will have a greater chance to be displayed to the customer and get additional leads. In the final stage of the subscription period, all dealers should get at least the minimum number of leads they expected.

Note that in many cases as the business grows, the number of leads received may be considerably more than what was guaranteed to the dealer. For instance, Dealers A, B, D, E, and F might have been set to receive 150% to 200% of guaranteed leads and Dealer C would have gotten 75% of leads. Lead balancing would shift some of the leads so that Dealer C obtained 100% of leads and all of the other dealers got well over 100%.

Although the invention has been described with respect to specific embodiments thereof, these embodiments are merely illustrative, and not restrictive of the invention. The description herein of illustrated embodiments of the invention, including the description in the Abstract and Summary, is not intended to be exhaustive or to limit the invention to the precise forms disclosed herein (and in particular, the inclusion of any particular embodiment, feature or function within the Abstract or Summary is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Embodiments discussed herein can be implemented in a computer communicatively coupled to a network (for example, the Internet), another computer, or in a standalone computer. As is known to those skilled in the art, a suitable computer can include a central processing unit (“CPU”), at least one read-only memory (“ROM”), at least one random access memory (“RAM”), at least one hard drive (“HD”), and one or more input/output (“I/O”) device(s). The I/O devices can include a keyboard, monitor, printer, electronic pointing device (for example, mouse, trackball, stylus, touch pad, etc.), or the like.

ROM, RAM, and HD are computer memories for storing computer-executable instructions executable by the CPU or capable of being complied or interpreted to be executable by the CPU. The processes described herein may be implemented in suitable computer-executable instructions that may reside on a non-transitory computer readable medium (for example, ROM, RAM, and HD, etc.), hardware circuitry or the like, or any combination thereof. Within this disclosure, the term “computer readable medium” or is not limited to ROM, RAM, and HD and can include any type of data storage medium that can be read by a processor. Examples of computer-readable storage media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, and other appropriate computer memories and data storage devices. Thus, a computer-readable medium may refer to a memory, a disk, a data cartridge, a data backup magnetic tape, a floppy diskette, a flash memory drive, an optical data storage drive, a CD-ROM, ROM, RAM, HD, or the like.

Any suitable programming language can be used to implement the routines, methods or programs of embodiments of the invention described herein, including C, C++, Java, JavaScript, HTML, or any other programming or scripting code, etc. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software embodied on hardware, firmware or any combination thereof.

Embodiments described herein can be implemented in the form of control logic in hardware or a combination of software and hardware. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code an of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more general purpose digital computers, by using application specific integrated circuits, programmable logic devices, field programmable gate arrays, optical, chemical, biological, quantum or nanoengineered systems, components and mechanisms may be used. In general, the functions of the invention can be achieved by any means as is known in the art. For example, distributed, or networked systems, components and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory. Such computer-readable medium shall generally be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer readable media storing computer instructions translatable by one or more processors in a computing environment.

A “computer” or “processor” may include any hardware system, mechanism or component that processes data, signals or other information. A computer or processor can include a system with a general-purpose central processing unit, multiple processing units, dedicated circuitry for achieving functionality, or other systems. Processing need not be limited to a geographic location, or have temporal limitations. For example, a computer or processor can perform its functions in “real-time,” “offline,” in a “batch mode,” etc. Portions of processing can be performed at different times and at different locations, by different (or the same) processing systems.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, process, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated otherwise (i.e., that the reference “a” or “an” clearly indicates only the singular or only the plural). Also, as used in the description herein, the meaning of “in” includes “in” and “on” unless the context clearly dictates otherwise.

Although the foregoing specification describes specific embodiments, numerous changes in the details of the embodiments disclosed herein and additional embodiments will be apparent to, and may be made by, persons of ordinary skill in the art having reference to this disclosure. In this context, the specification and figures are to be regarded in an illustrative rather than a restrictive sense, and all such modifications are intended to be included within the scope of this disclosure. Accordingly, the scope of this disclosure should be determined by the following claims and their legal equivalents.

What is claimed is:

1. A method for subscription pricing, comprising:
estimating, by a computer having a processor and a memory, a number of leads to be provided by an entity to a dealer in a dealer network associated with the entity;
estimating a price per lead based at least in part on the estimated number of leads;
determining a preliminary subscription price for the dealer based on the estimated number of leads and the estimated price per lead; and
applying one or more decision rules imposing one or more constraints to the preliminary subscription price to thereby determine a final subscription price for the dealer.

2. The method according to claim 1, wherein the applying further comprises adjusting the final subscription price for the dealer based at least in part on an actual number of sales by the dealer, the sales resulting from leads provided by the entity to the dealer.

3. The method according to claim 1, wherein the applying further comprises constraining or dampening a variance of the estimated price per lead and an actual number of leads provided by the entity to the dealer.

4. The method according to claim 1, wherein the one or more decision rules are applied depending upon whether the dealer is a potential subscriber member or an existing member of the dealer network associated with the entity.

5. The method according to claim 1, wherein at least one of the one or more constraints is a dampening factor associated with the number of leads or the price per lead.

6. The method according to claim 1, further comprising:
determining a sales estimate for the dealer based at least in part on the estimated number of leads for the dealer and a close rate for the dealer; and
determining a target price per sale using the sales estimate for the dealer, wherein the estimated price per lead is determined using the target price per sale.

7. The method according to claim 6, wherein the close rate for the dealer is an estimated close rate determined based on marketing data, one or more geographic factors, one or more seasonality factors, historical data associated with the dealer over a time period, or a combination thereof.

8. A computer program product comprising at least one non-transitory computer-readable medium storing instructions translatable by a computer to perform:
estimating a number of leads to be provided by an entity to a dealer in a dealer network associated with the entity;
estimating a price per lead based at least in part on the estimated number of leads;
determining a preliminary subscription price for the dealer based on the estimated number of leads and the estimated price per lead; and
applying one or more decision rules imposing one or more constraints to the preliminary subscription price to thereby determine a final subscription price for the dealer.

9. The computer program product of claim 8, wherein the applying further comprises adjusting the final subscription price for the dealer based at least in part on an actual number of sales by the dealer, the sales resulting from leads provided by the entity to the dealer.

10. The computer program product of claim 8, wherein the applying further comprises constraining or dampening a variance of the estimated price per lead and an actual number of leads provided by the entity to the dealer.

11. The computer program product of claim 8, wherein the one or more decision rules are applied depending upon whether the dealer is a potential subscriber member or an existing member of the dealer network associated with the entity.

12. The computer program product of claim 8, wherein at least one of the one or more constraints is a dampening factor associated with the number of leads or the price per lead.

13. The computer program product of claim 8, wherein the at least one non-transitory computer-readable medium further storing instructions translatable by the computer to perform:
determining a sales estimate for the dealer based at least in part on the estimated number of leads for the dealer and a close rate for the dealer; and
determining a target price per sale using the sales estimate for the dealer, wherein the estimated price per lead is determined using the target price per sale.

14. The computer program product of claim 13, wherein the close rate for the dealer is an estimated close rate determined based on marketing data, one or more geographic factors, one or more seasonality factors, historical data associated with the dealer over a time period, or a combination thereof.

15. A system, comprising:
at least one processor; and
at least one non-transitory computer-readable medium storing instructions translatable by the at least one processor to perform:
estimating a number of leads to be provided by an entity to a dealer in a dealer network associated with the entity;
estimating a price per lead based at least in part on the estimated number of leads;
determining a preliminary subscription price for the dealer based on the estimated number of leads and the estimated price per lead; and
applying one or more decision rules imposing one or more constraints to the preliminary subscription price to thereby determine a final subscription price for the dealer.

16. The system of claim 15, wherein the applying further comprises adjusting the final subscription price for the dealer based at least in part on an actual number of sales by the dealer, the sales resulting from leads provided by the entity to the dealer.

17. The system of claim 15, wherein the applying further comprises constraining or dampening a variance of the estimated price per lead and an actual number of leads provided by the entity to the dealer.

18. The system of claim 15, wherein the one or more decision rules are applied depending upon whether the dealer is a potential subscriber member or an existing member of the dealer network associated with the entity.

19. The system of claim 15, wherein at least one of the one or more constraints is a dampening factor associated with the number of leads or the price per lead.

20. The system of claim 15, wherein the at least one non-transitory computer-readable medium further storing instructions translatable by the at least one processor to perform:
determining a sales estimate for the dealer based at least in part on the estimated number of leads for the dealer and a close rate for the dealer; and
determining a target price per sale using the sales estimate for the dealer, wherein the estimated price per lead is determined using the target price per sale.

21. The system of claim 20, wherein the close rate for the dealer is an estimated close rate determined based on marketing data, one or more geographic factors, one or more seasonality factors, historical data associated with the dealer over a time period, or a combination thereof.
